(19) United States
(12) Patent Application Publication
(10) Pub. No.: US 2014/0063052 A1
(43) Pub. Date: Mar. 6, 2014

(54) TRANSPARENT DISPLAY APPARATUS AND METHOD OF DRIVING THE SAME

(71) Applicant: SAMSUNG DISPLAY CO., LTD., Yongin-city (KR)

(72) Inventor: Uk Chul CHOI, Cheonan-si (KR)

(73) Assignee: Samsung Display Co., Ltd., Yongin-city (KR)

(21) Appl. No.: 13/748,122

(22) Filed: Jan. 23, 2013

(30) Foreign Application Priority Data
Aug. 29, 2012 (KR) 10-2012-0095082

(51) Int. Cl. G09G 5/377; G06F 3/00

(52) U.S. Cl. CPC G09G 5/377; G06F 3/005
USPC 345/629; 345/156

(57) ABSTRACT

A transparent display apparatus includes a display panel that displays an image, a front camera, a rear camera, and a timing controller. The front camera is disposed on a front surface of the display panel and takes a picture of a user to generate a user data. The rear camera is disposed on a rear surface of the display panel and takes a picture of a background to generate a whole background data. The timing controller receives an image data, the user data, and the whole background data, generates a background data on the basis of the user data and the whole background data, and merges the image data and the background data to generate a modulation data. The user perceives the image obtained by merging the image data with the background data.

### CROSS-REFERENCE TO RELATED APPLICATION

This application claims priority from and the benefit of Korean Patent Application No. 10-2012-0095082, filed on Aug. 29, 2012, which is hereby incorporated by reference for all purposes as if fully set forth herein.

### BACKGROUND

1. Field

Exemplary embodiments of the present invention relate to a transparent display apparatus and a method of driving the transparent display apparatus.

2. Discussion of the Background

In recent years, studies have been conducted regarding a transparent display apparatus that allows an object at a rear side thereof to be seen, as well as being capable of implementing an image thereon. The transparent display apparatus includes a non-self-emissive transparent display device that requires a separate light source, e.g., a liquid crystal display, and a self-emissive transparent display device that does not require the separate light source, e.g., an organic electroluminescent display.

Color reproducibility of the transparent display apparatus and transmittance of light incident to the transparent display apparatus are in conflict with each other. That is, when the light transmittance of the transparent display apparatus is increased, the object at the rear side of the transparent display apparatus is vividly perceived, but color reproducibility of images to be displayed on the transparent display apparatus is deteriorated. In contrast, when the light transmittance of the transparent display apparatus is decreased, the color reproducibility of the images to be displayed on the transparent display apparatus is improved, but the object at the rear side of the transparent display apparatus appears blurred.

The above information disclosed in this Background section is only for enhancement of understanding of the background of the invention and, therefore, it may contain information that does not form any part of the prior art nor what the prior art may suggest to a person of ordinary skill in the art.

### SUMMARY

Exemplary embodiments of the present invention provide a transparent display apparatus capable of allowing an object at a rear side thereof to be seen without causing deterioration in color reproducibility.

Exemplary embodiments of the present invention also provide a method of driving the transparent display apparatus.

Additional features of the invention will be set forth in the description which follows, and in part will be apparent from the description, or may be learned by practice of the invention.

An exemplary embodiment of the present invention discloses a transparent display apparatus including a display panel configured to display an image, a front camera, a rear camera, a timing controller, a gate driver, and a data driver.

The front camera is disposed on a front surface of the display panel and is configured to take a picture of a user to generate a user data. The rear camera is disposed on a rear surface of the display panel and is configured to take a picture of a background to generate a whole background data.

The timing controller is configured to receive the image data, the user data, and the whole background data; generate a background data based on the user data and the whole background data; and merge the image data and the background data to generate a modulation data. The data driver is configured to receive the modulation data; convert the modulation data to a data signal; and output the data signal to the display panel.

An exemplary embodiment of the present invention also discloses a method of driving a transparent display apparatus as follows. A background of a rear side of a display panel is taken by using a rear camera to generate a whole background data, and a picture of a user positioned in front of the display panel is taken by using a front camera to generate a user data. Then, a gaze position of the user is detected based on the user data. A portion of the whole background data, which corresponds to the gaze position, is selected to generate a background data. An image data is then merged with the background data to generate a modulation data, and the modulation data is displayed on the display panel.

An exemplary embodiment of the present invention also discloses a method of driving a display apparatus including obtaining first background data related to a background perceivable through a display panel, obtaining user data related to a viewer located at an opposite side of the display panel from the background, selecting a portion of the first background data based on the user data to obtain second background data, determining modulation data using image data and the second background data, and displaying, on the display panel, an image corresponding to the modulation data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a transparent display apparatus according to an exemplary embodiment of the present invention.

FIG. 2 is a block diagram showing the transparent display apparatus shown in FIG. 1.

FIG. 3 is a block diagram showing a timing controller shown in FIG. 2.

FIG. 4 is a view showing a relationship between a user and the transparent display apparatus shown in FIG. 1.

FIG. 5 is a view showing a background image displayed using background data, a data image displayed using image data, and a modulation image displayed using modulation data.

FIG. 6 is a flowchart showing a method of driving a transparent display device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity

It will be understood that when an element or layer is referred to as being “on,” “connected to,” or “coupled to” another element or layer, it can be directly on, connected to, or coupled to the other element or layer, or intervening elements or layers may be present. In contrast, when an element is referred to as being “directly on,” “directly connected to,” or “directly coupled to” another element or layer, there are no intervening elements or layers present. Like reference numerals in the drawings denote like elements. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be further understood that for the purposes of this disclosure, “at least one of X, Y, and Z” can be construed as X only, Y only, Z only, or any combination of two or more items X, Y, and Z (e.g., xyz, XYY, YZ, ZZ).

Hereinafter, the present invention will be explained in detail with reference to the accompanying drawings.

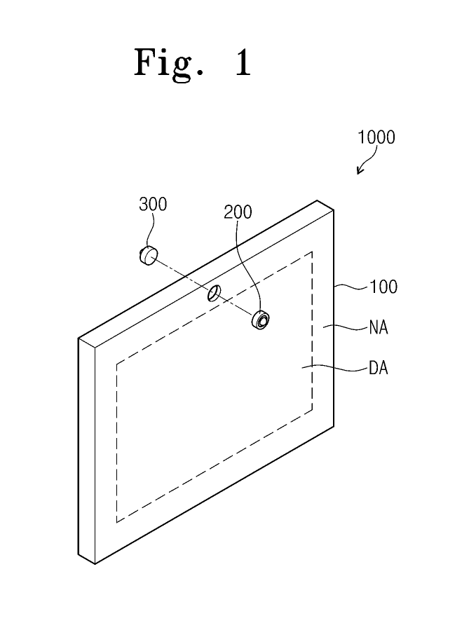

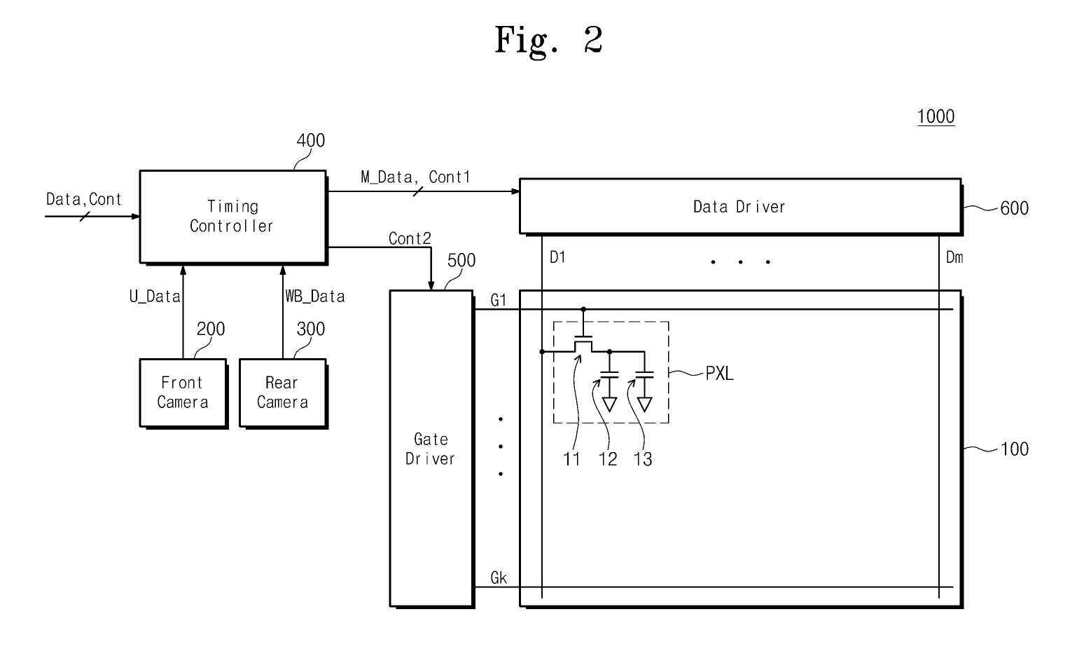

FIG. 1 is a perspective view showing a transparent display apparatus 1000 according to an exemplary embodiment of the present invention, and FIG. 2 is a block diagram showing the transparent display apparatus 1000 shown in FIG. 1.

Referring to FIGS. 1 and 2, the transparent display apparatus 1000 includes a display panel 100, a front camera 200, a rear camera 300, a timing controller 400, a gate driver 500, and a data driver 600.

The display panel 100 displays an image. The display panel 100 includes a display area DA and a non-display area NA disposed adjacent to at least a portion of the display area DA. In addition, the display panel 100 includes a front surface and a rear surface, which face each other. The front surface may be a surface on which a user views the image.

Various display panels, such as an organic light emitting display panel, a liquid crystal display panel, a plasma display panel, an electrophoretic display panel, an electrowetting display panel, etc., may be used as the display panel 100. In the present exemplary embodiment, the liquid crystal display panel will be described as the display panel 100.

The display panel 100 includes a plurality of gate lines G1 to Gk configured to receive gate signals and a plurality of data lines D1 to Dm configured to receive data signals, such as data voltages. The gate lines G1 to Gk are insulated from the data lines D1 to Dm while crossing the data lines D1 to Dm. The display panel 100 includes a plurality of pixel areas defined thereon, and pixels are arranged in the pixel areas, respectively. An equivalent circuit diagram corresponding to one pixel PXL has been shown in FIG. 2. As shown in FIG. 2, the pixel PXL includes a thin film transistor 11, a liquid crystal capacitor 12, and a storage capacitor 13.

Although not shown in FIGS. 1 and 2, the thin film transistor 11 includes a gate electrode, a source electrode, and a drain electrode. As an example, the gate electrode is connected to a first gate line G1 of the gate lines G1 to Gk, the source electrode is connected to a first data line D1 of the data lines D1 to Dm, and the drain electrode is connected to the liquid crystal capacitor 12 and the storage capacitor 13. The liquid crystal capacitor 12 and the storage capacitor 13 are connected in parallel to the drain electrode.

In addition, the display panel 100 includes a first display substrate, a second display substrate facing the first display substrate, and a liquid crystal layer interposed between the first display substrate and the second display substrate (all not shown).

The gate lines G1 to Gk, the data lines D1 to Dm, and a pixel electrode (not shown) that serves as a first electrode of the liquid crystal capacitor 12 are disposed on the first display substrate. The thin film transistor 11 is turned on in response to a corresponding gate signal of the gate signals and applies a corresponding data voltage to the pixel electrode.

The second display substrate includes a common electrode (not shown) formed thereon. The common electrode serves as a second electrode of the liquid crystal capacitor 12 and is configured to receive a reference voltage. The liquid crystal layer is disposed between the pixel electrode and the common electrode to serve as a dielectric substance. The liquid crystal capacitor 12 is charged with a voltage corresponding to an electric potential difference between the data voltage and the reference voltage.

The front camera 200 is disposed on the front surface of the display panel 100 to correspond to the non-display area NA. Although shown at an upper, central location of the display panel 100, the front camera 200 may be disposed at any location in the non-display area NA. The front camera 200 takes a picture of the user to generate a user data U_Data.

The rear camera 300 is disposed on the rear surface of the display panel 100 to correspond to the non-display area NA. Although shown at an upper, central location of the display panel 100, the rear camera 300 may be disposed at any location in the non-display area NA. Furthermore, although shown in corresponding positions, the front and rear cameras 200 and 300 may be disposed at different positions, such as, for example, opposite corners of the display panel 100. The rear camera 300 takes a picture of the background of the display panel 100 to generate a whole background data WB_Data. The front camera 200 and the rear camera 300 may be real time motion picture cameras.

The timing controller 400 receives an image data Data and a control signal Cont from an external source (not shown), the user data U_Data from the front camera 200, and the whole background data WB_Data from the rear camera 300.

The control signal Cont includes a horizontal synchronization signal, a vertical synchronization signal, a main clock signal, a data enable signal, etc.

The timing controller 400 generates a background data on the basis of the user data U_Data and the whole background data WB_Data. In addition, the timing controller 400 generates a modulation data M_Data using the background data and the image data Data.

The timing controller 400 applies a data control signal Cont1, e.g., an output start signal, a horizontal start signal, a horizontal clock signal, a polarity inversion signal, etc., and the modulation data M_Data to the data driver 600 and applies a gate control signal Cont2, e.g., a vertical start signal, a vertical clock signal, a vertical clock bar signal, etc., to the gate driver 500.

The gate driver 500 is electrically connected to the gate lines G1 to Gk disposed on the display panel 100 to apply the gate signals to the gate lines G1 to Gk. In detail, the gate driver 500 generates the gate signals used to drive the gate lines G1 to Gk based on the gate control signal Cont2 from the timing controller 400, and sequentially outputs the generated gate signals to the gate lines G1 to Gk.

The data driver 600 converts the modulation data M_Data to data voltages in response to the data control signal Cont1 and applies the data voltages to the data lines D1 to Dm.

At least a portion of the display apparatus 1000 may be transparent. Here, “transparent” includes varying degrees of transparency. Thus, a “transparent” display includes a semi-transparent display. In detail, at least the display area DA of the display panel 100 may be transparent. Accordingly, the user may perceive the background of the rear side of the display apparatus 1000 through the display area DA of the display panel 100.

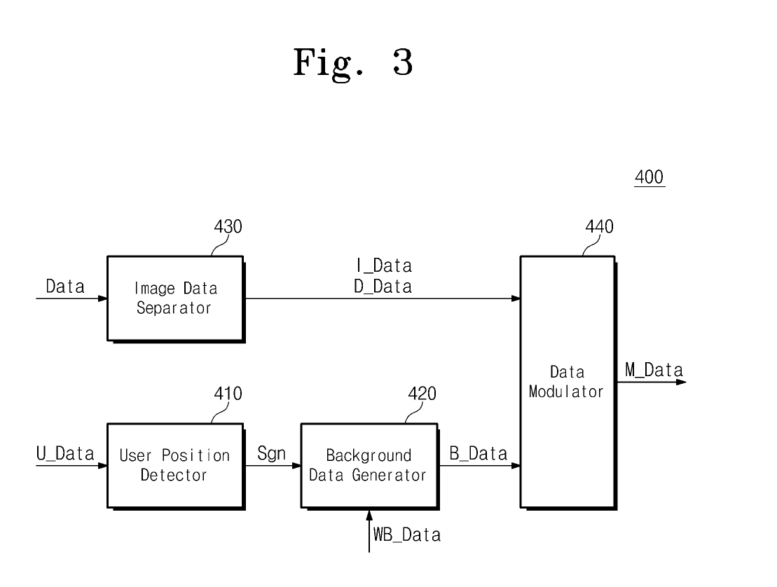

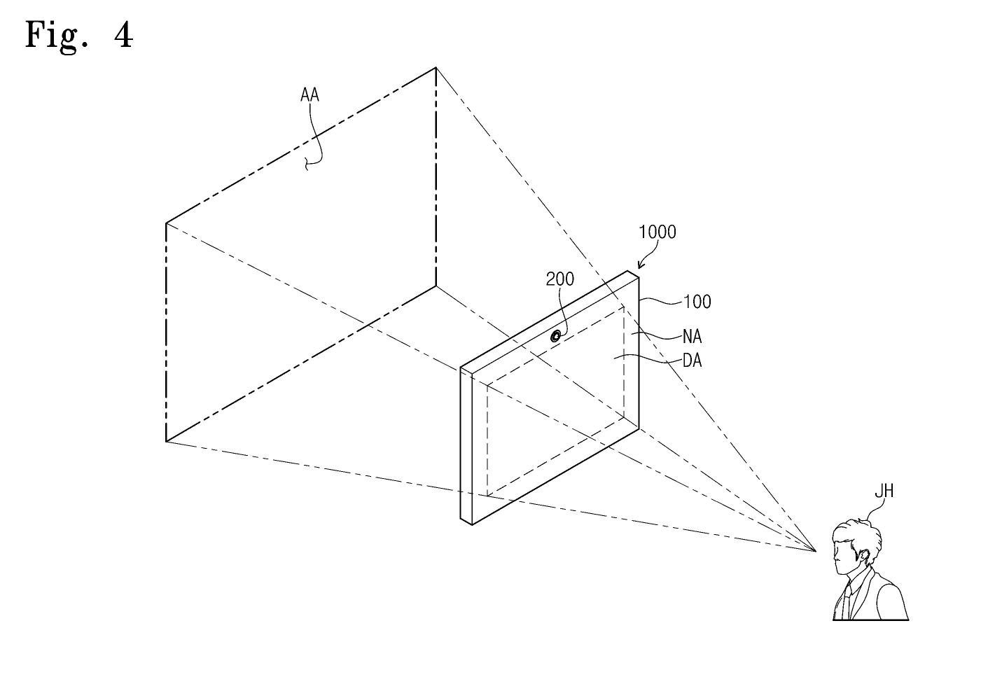

FIG. 3 is a block diagram showing the timing controller 400 shown in FIG. 2, and FIG. 4 is a view showing a relationship between the user JH and the transparent display apparatus 1000 shown in FIG. 1.

Referring to FIGS. 3 and 4, the timing controller 400 includes a user position detector 410, a background data generator 420, an image data separator 430, and a data modulator 440.

The user position detector 410 receives the user data U_Data and analyzes the user data U_Data to detect a gaze position Sgn of the user JH. The gaze position Sgn includes information related to a distance between the user JH and the display apparatus 1000 and a gaze direction of the user JH. In detail, the user position detector 410 detects positions of eye, nose, and mouse of the user JH on the basis of the user data U_Data to recognize facial features of the user JH. The user position detector 410 calculates the distance between the user JH and the transparent display apparatus 1000 and the gaze direction of the user JH on the basis of the recognized facial features of the user JH.

The background data generator 420 receives the gaze position Sgn from the user position detector 410 and receives the whole background data WB_Data. The background data generator 420 selects a portion of the whole background data WB_Data, which corresponds to the gaze position Sgn, to generate the background data B_Data.

The background data B_Data may be the portion of the whole background data WB_Data corresponding to an area AA perceived by the user JH through the display area DA of the display panel 100. In other words, the background data B_Data corresponds to an area obtained by projecting the display area DA of the display panel 100 on the whole background data WB_Data from the gaze position Sgn. Accordingly, a real background perceived by the user through the transparent display apparatus 1000 and the image displayed by using the background data B_Data can be perceived by the user.

The image data separator 430 receives the image data Data and separates the image data Data into an information image data I_Data and a dummy image data D_Data. The information image data I_Data includes information related to the image to be displayed, and the dummy image data D_Data includes image data except for the information image data I_Data, e.g., information related to the image displayed in white color.

The data modulator 440 receives the background data B_Data from the background data generator 420 and receives the information image data I_Data and the dummy image data D_Data from the image data separator 430. The data modulator 440 merges the information image data I_Data and the background data B_Data and merges the dummy image data D_Data and the background data B_Data.

The modulation data M_Data includes information related to an image obtained by overlapping the image displayed using the background data B_Data and the image displayed using the image data Data. However, the information image data I_Data and the dummy image data D_Data may be merged with the background data B_Data in different ratios.

The information image data I_Data is merged with the background data B_Data by the data modulator 440 in a first ratio, and thus the data modulator 440 generates a first modulation data. In addition, the dummy image data D_Data is merged with the background data B by the data modulator 440 in a second ratio different from the first ratio, so that the data modulator 440 generates a second modulation data.

In this case, the first and second ratios refer to a ratio of brightness and chroma in an image displayed using the background data B_Data, the information image data I_Data, and the dummy image data D_Data.

According to the first ratio, the information image data I_Data is merged with the background data B_Data in a ratio of 99:1. Accordingly, about 99% of the first modulation data has a brightness and chroma taken from the image displayed using the information image data I_Data and about 1% of the first modulation data has the brightness and chroma taken from the image displayed using the background data B_Data.

According to the second ratio, the dummy image data D_Data is merged with the background data B_Data in a ratio of 3:7. Thus, about 30% of the second modulation data has a brightness and chroma of about 30% taken from the image displayed using the dummy image data D_Data and about 70% of the second modulation data has the brightness and chroma taken from the image displayed using the background data B_Data.

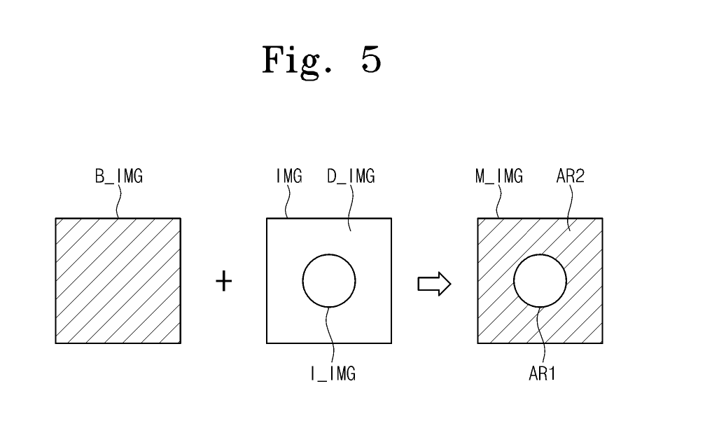

FIG. 5 is a view showing the background image B_IMG displayed using the background data B_Data, the data image IMG displayed using the image data Data, and the modulation image M_IMG displayed using modulation data.

The data image IMG includes an information image I_IMG displayed using the information image data I_Data and a dummy image D_IMG displayed using the dummy image data D_Data.

The modulation image M_IMG includes a first area AR1 and a second area AR2 which excludes the first area AR1. The first area AR1 corresponds to the information image I_IMG.

The modulation image M_IMG is obtained by overlapping the data image IMG with the background image B_IMG.

In the first area AR1, the information image I_IMG is displayed to have the brightness and chroma making up about 99% and the background image B_IMG is displayed to have the brightness and chroma making up about 1%.

In the second area AR2, the dummy image D_IMG is displayed to have the brightness and chroma making up about 30% and the background image B_IMG is displayed to have the brightness and chroma making up about 70%. Thus, the user may perceive the background image B_IMG as a real background perceived through the transparent display apparatus 1000 shown in FIG. 1.

According to the transparent display apparatus 1000, the display panel 100 substantially simultaneously displays the image and the background by using the modulation data M_Data, and thus the user may vividly perceive the image and the background. In other words, because the transparent display apparatus 1000 has high color reproducibility, the user may vividly perceive not only the image but also the background even though the light transmittance thereof is reduced.

In addition, the information image data I_Data and the dummy image data D_Data are merged with the background data B_Data in the different ratios, so that the user may realistically perceive the image and the background.

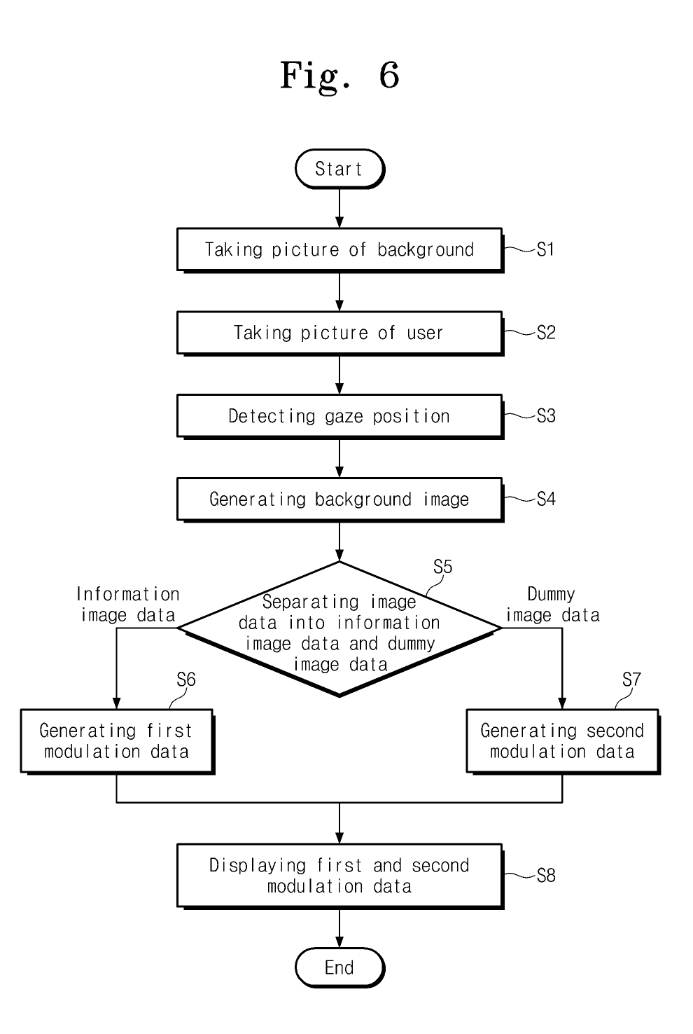

FIG. 6 is a flowchart showing a method of driving a transparent display device according to an exemplary embodiment of the present invention.

Referring to FIGS. 1, 4, and 6, a picture of the background of the rear side of the display panel 100 is taken by the rear camera 300 to generate the whole background data (S1).

Then, a picture of the user JH positioned in front of the display panel 100 is taken by the front camera 200 to generate the user data (S2).

The gaze position of the user JH is detected on the basis of the user data (S3). In this case, the distance between the user JH and the transparent display apparatus 1000 and the gaze direction JH of the user JH may be calculated by recognizing the facial features of the user JH and analyzing the facial features of the user JH.

After that, the portion of the whole background data, which corresponds to the gaze position, is selected and the background data is generated (S4). The background data may be the portion of the whole background data corresponding to the area AA perceived by the user JH through the display area DA of the display panel 100.

Then, the image data is separated into the information image data and the dummy image data (S5). Although this image data separation is shown in FIG. 6 to occur after S1-S4, it can occur before S1-S4 or at any point in between S1-S4.

When the image data is the information image data, the information image data and the background data are merged with each other in a first ratio so as to generate the first modulation data (S6). In this case, the information image data I_Data is merged with the background data B_Data in a ratio of 99:1.

When the image data is the dummy image data, the dummy image data and the background data are merged with each other in a second ratio so as to generate the second modulation data (S7). In this case, the dummy image data D_Data is merged with the background data B_Data in a ratio of 3:7.

Then, the first modulation data and the second modulation data are displayed on the display panel 100 (S8).

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of driving a transparent display apparatus comprising:
taking a picture of a background of a rear side of a display panel using a rear camera to generate a whole background data;
taking a picture of a user positioned in front of the display panel using a front camera to generate a user data;
detecting a gaze position of the user based on the user data;
selecting a portion of the whole background data, which corresponds to the gaze position, to generate a background data;
merging an image data with the background data to generate a modulation data; and
displaying the modulation data on the display panel.

2. The method of claim 1, wherein the background data corresponds to the portion of the whole background data that corresponds to an area perceived by the user through a display area of the display panel.

3. The method of claim 1, wherein the generating of the modulation data comprises:
separating the image data into an information image data and a dummy image data;
merging the information image data with the background data in a first ratio to generate a first modulation data; and
merging the dummy image data with the background data in a second ratio to generate a second modulation data.

4. The method of claim 3, wherein the information image data and the background data are merged with each other in a ratio of 99:1.

5. The method of claim 3, wherein the dummy image data and the background data are merged with each other in a ratio of 3:7.

6. A transparent display apparatus comprising:
a display panel configured to display an image;
a front camera disposed at a front of the display panel and configured to take a picture of a user to generate a user data;
a rear camera disposed at a rear of the display panel and configured to take a picture of a background to generate a whole background data;
a timing controller configured to receive an image data, the user data, and the whole background data, generate a background data on the basis of the user data and the whole background data, and merge the image data and the background data to generate a modulation data; and
a data driver configured to receive the modulation data, convert the modulation data to a data signal, and output the data signal to the display panel.

7. The transparent display apparatus of claim 6, wherein the timing controller comprises:
a user position detector configured to analyze the user data to detect a gaze position of the user;
a background data generator configured to select a portion of the whole background data, which corresponds to the gaze position, to generate a background data; and
a data modulator configured to merge the image data with the background data to generate the modulation data.

8. The transparent display apparatus of claim 7, wherein the background data corresponds to the portion of the whole background data that corresponds to an area perceived by the user through a display area of the display panel.

9. The transparent display apparatus of claim 7, wherein the timing controller further comprises an image data separator configured to separate the image data into an information image data and a dummy image data.

10. The transparent display apparatus of claim 9, wherein the data modulator is configured to merge the information image data with the background data in a first ratio and the dummy image data with the background data in a second ratio different from the first ratio.

11. The display apparatus of claim 10, wherein the information image data and the background data are merged with each other in the first ratio of 99:1, and the dummy image data and the background data are merged with each other in the second ratio of 3:7.

12. The method of claim 3, wherein the information image data, the dummy image data, and the background data in the first and second ratios comprise values of brightness and chroma in a displayed image.

13. The display apparatus of claim 10, wherein the information image data, the dummy image data, and the background data in the first and second ratios comprise values of brightness and chroma in a displayed image.

14. A method of driving a display apparatus, comprising:
obtaining first background data related to a background perceivable through a display panel;
obtaining user data related to a viewer located at an opposite side of the display panel from the background;
selecting a portion of the first background data based on the user data to obtain second background data;
determining modulation data using image data and the second background data; and
displaying, on the display panel, an image corresponding to the modulation data.

15. The method of claim 14, wherein selecting a portion of the first background data based on the user data comprises determining a gaze position of the viewer based on the user data, the selected portion of the first background data corresponding to the gaze position.

16. The method of claim 15, wherein determining modulation data comprises:
separating the image data into an information image data and a dummy image data;
merging the information image data with the second background data in a first ratio to generate first modulation data; and
merging the dummy image data with the second background data in a second ratio to generate second modulation data.

17. The method of claim 16, wherein the first ratio differs from the second ratio.

18. The method of claim 17, wherein the information image data and the second background data are merged with each other in a ratio of 99:1.

19. The method of claim 17, wherein the dummy image data and the second background data are merged with each other in a ratio of 3:7.
